(19) United States
(12) Patent Application Publication
(10) Pub. No.: US 2025/0027599 A1
(43) Pub. Date: Jan. 23, 2025

(54) DEFLECTABLE FOLDING BRACKET

(71) Applicant: Shenzhen Chuangboyou Technology Development Co., LTD, Shenzhen (CN)

(72) Inventor: Lili Wang, Shenzhen (CN)

(21) Appl. No.: 18/633,569

(22) Filed: Apr. 12, 2024

Related U.S. Application Data
(63) Continuation-in-part of application No. 18/451,716, filed on Aug. 17, 2023, now abandoned.

(30) Foreign Application Priority Data
Jul. 20, 2023 (CN) 202310897976.2

(51) Int. Cl. F16M 11/38

(52) U.S. Cl. CPC F16M 11/38

(57) ABSTRACT

Provided is a deflectable folding bracket including a horizontal bar and two bases respectively arranged at two ends of the horizontal bar, wherein each base comprises a first housing and a second housing forming a housing space with the first housing, an elastic member is arranged in the housing space, the first housing has a hollow cylindrical component, the second housing has a deflection shaft penetrating the hollow cylindrical component, the deflection shaft is parallel to the horizontal bar, the second housing can pivot around the deflection shaft relative to the first housing, and the base further comprises a plurality of first supporting components connected to the first housing and a plurality of second supporting components connected to the second housing.

This application claims priority to Chinese Patent Application No. CN202310897976.2, filed on Jul. 20, 2023, the contents of which are incorporated herein by reference.

This application is a continuation-in-part of U.S. patent application Ser. No. 18/451,716, filed on Aug. 17, 2023.

### TECHNICAL FIELD

The present invention relates to the technical field of leisure products, in particular to a deflectable folding bracket.

### BACKGROUND

As economy develops, urban people often choose to go out and enjoy outdoor life to relax.

When doing outdoor activities, such as fishing, camping, etc., people usually need portable furniture such as tables, chairs, and hammocks. However, common portable furniture has limited functions and lacks comfort and interest when used.

### SUMMARY

Based on this, it is desired to provide a deflectable folding bracket to solve the problem of limited use modes of portable furniture.

The present invention provides a deflectable folding bracket, including a horizontal bar and two bases respectively arranged at two ends of the horizontal bar, wherein each base comprises a first housing and a second housing forming a housing space with the first housing, an elastic member is arranged in the housing space, the first housing has a hollow cylindrical component, the second housing has a deflection shaft penetrating the hollow cylindrical component, the deflection shaft is parallel to the horizontal bar, the second housing can pivot around the deflection shaft relative to the first housing, and the base further comprises a plurality of first supporting components connected to the first housing and a plurality of second supporting components connected to the second housing.

Preferably, the hollow cylindrical component is arranged at one end of the first housing, and the elastic member is a spring arranged at one end of the first housing away from the hollow cylindrical component.

Preferably, the first housing has a first limit groove, and the second housing has a second limit groove, one end of the spring is clamped in the first limit groove, and the other end of the spring is clamped in the second limit groove.

Preferably, the hollow cylindrical component is arranged in the housing space, the elastic member comprises a first spring arranged on one side of the deflection shaft and a second spring arranged on an other side of the deflection shaft.

Preferably, the first spring is shorter than the second spring in an uncompressed state.

Preferably, the hollow cylindrical component is arranged in the housing space, the elastic member is an elastic strip arranged on the hollow cylindrical component.

Preferably, the clastic strip is wave shaped.

Preferably, an end of each first supporting component connected to the first housing is provided with a leg tooth portion, and the leg tooth portions of adjacent first supporting components are engaged with each other.

Preferably, an end of each second supporting component connected to the second housing is provided with an arm tooth portion, and the arm tooth portions of adjacent second supporting components are engaged with each other.

Preferably, each second supporting component comprises a front second supporting component and a rear second supporting component, the rear second supporting component is longer than the front second supporting component, and the deflection shaft is arranged toward the front second supporting component.

Preferably, the first housing is at least partially received in the second housing, and the second housing has a horizontal bar joint to be connected to the horizontal bar.

The deflectable folding bracket of the present invention includes a horizontal bar and two bases respectively arranged at two ends of the horizontal bar, wherein each base comprises a first housing and a second housing forming a housing space with the first housing, an elastic member is arranged in the housing space, the first housing has a hollow cylindrical component, the second housing has a deflection shaft penetrating the hollow cylindrical component, the deflection shaft is parallel to the horizontal bar, the second housing can pivot around the deflection shaft relative to the first housing, and the base further comprises a plurality of first supporting components connected to the first housing and a plurality of second supporting components connected to the second housing. Since the second housing can pivot relative to the first housing and the elastic member is arranged between the first housing and the second housing, the folding bracket of the present invention can be deflected during use without overturning.

### BRIEF DESCRIPTION OF DRAWINGS

In order to more clearly illustrate the technical solutions in the specific embodiments of the present invention or in the prior art, drawings to be used for description of embodiments or the prior art will be briefly introduced below. Obviously, drawings referred to in the following description are some embodiments of the present invention, and those of ordinary skill in the art may also obtain other drawings based on these drawings without paying creative efforts.

FIG. 1 is an assembled view of a deflectable folding bracket according to a first embodiment;

FIG. 2 is an assembled view of a base of the deflectable folding bracket according to the first embodiment;

FIG. 3 is an exploded view of the base of the deflectable folding bracket according to the first embodiment;

FIG. 4 is a cross-sectional view of the base of the deflectable folding bracket according to the first embodiment;

FIG. 5 is a perspective view of the deflectable folding bracket according to the first embodiment, shown without a cover plate for ease of illustration;

FIG. 6 is an exploded view of the base of the deflectable folding bracket according to a second embodiment;

FIG. 7 is a cross-sectional view of the base of the deflectable folding bracket according to the second embodiment;

FIG. 8 is a perspective view of the deflectable folding bracket according to the second embodiment, shown without a cover plate for ease of illustration;

FIG. 9 is a cross-sectional view of the base of the deflectable folding bracket according to the third embodiment; and

FIG. 10 is a cross-sectional view of the base of the deflectable folding bracket according to the fourth embodiment.

### DESCRIPTION OF EMBODIMENTS

The technical solutions in the invention will be described clearly and completely below in connection with the drawings, and it will be apparent that the embodiments described herein are merely a part of, not all the embodiments of the invention. All other embodiments obtained by a person of ordinary skill in the art based on the embodiments of the invention without creative efforts shall fall within the scope of the invention.

In the description of the invention, it should be noted that the orientation or positional relationship indicated by the terms “center”, “upper”, “lower”, “left”, “right”, “vertical”, “horizontal”, “inner”, “outer”, etc., is based on the orientation or positional relationship shown in the drawings. They are used only for the convenience of describing the invention and simplifying the description, rather than indicating or implying that the indicated device or element must have a specific orientation, or must be constructed and operated in a particular orientation, so they are not to be construed as limitations of the invention. In addition, the terms “first”, “second”, “third” and the like are used herein for descriptive purposes only, and should not be construed as indicating or implying relative importance.

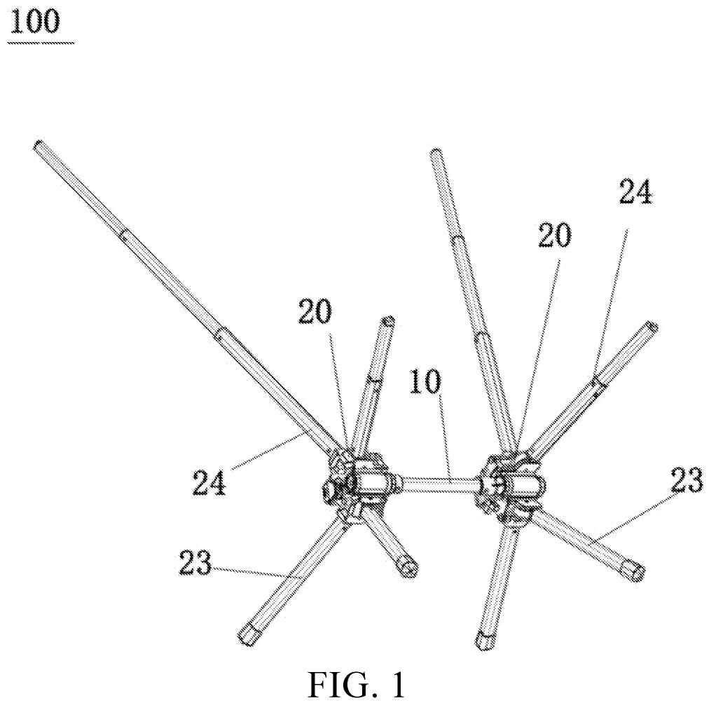

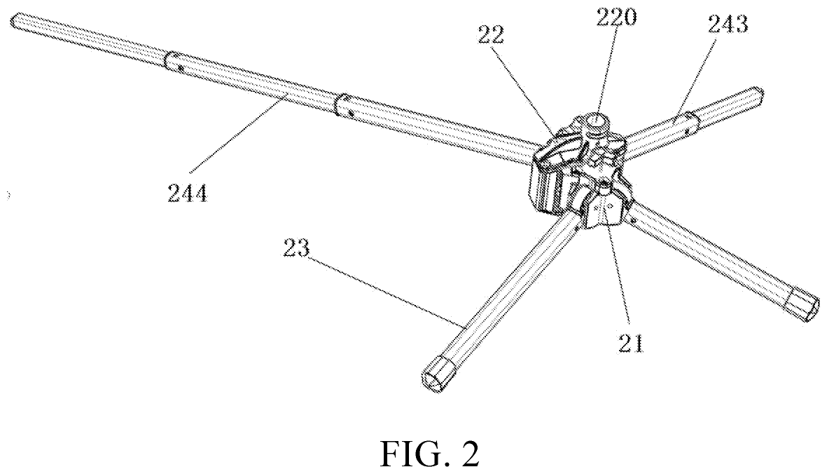

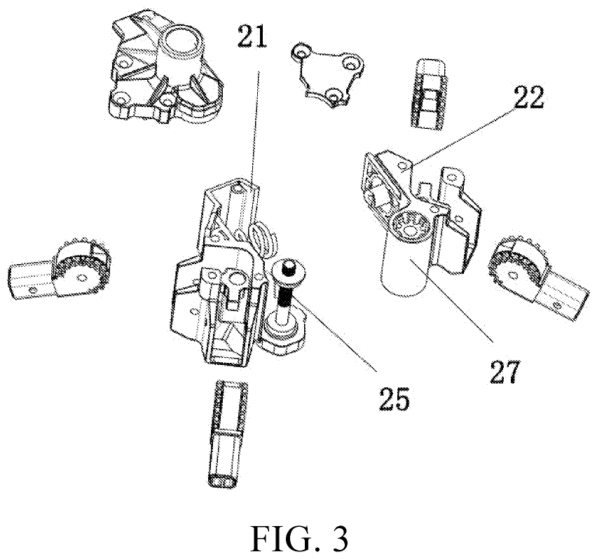

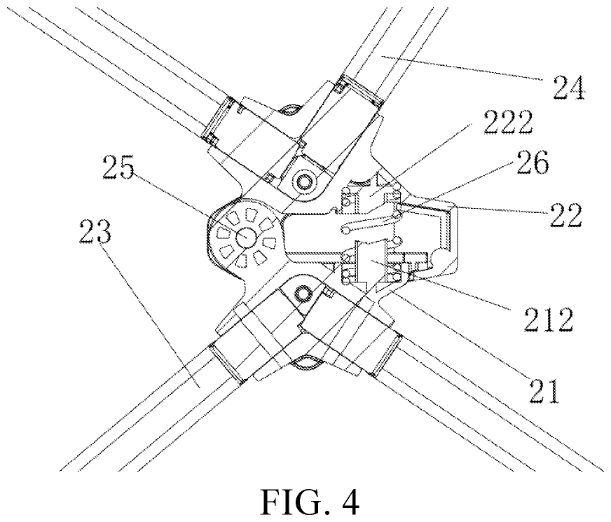

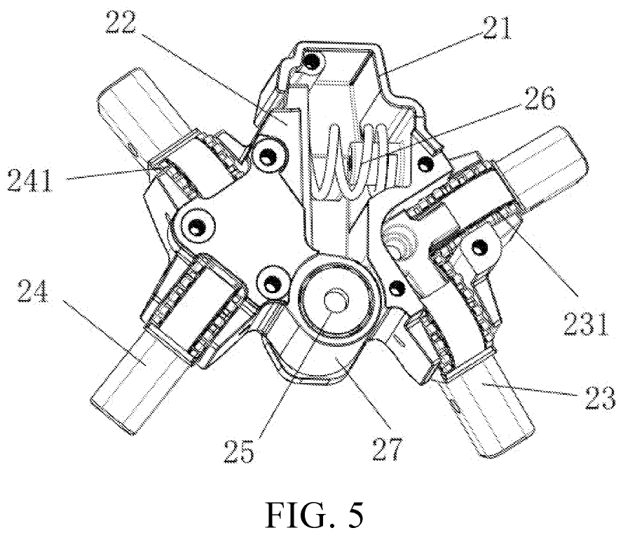

As shown in FIGS. 1-5, the present invention provides a deflectable folding bracket 100, including a horizontal bar 10 and two bases 20 respectively arranged at two ends of the horizontal bar 10, wherein each base 20 includes a first housing 21 and a second housing 22 forming a housing space with the first housing 21 and further includes a plurality of first supporting components 23 connected to the first housing 21 and a plurality of second supporting components 24 connected to the second housing 22.

In this embodiment, the first housing 21 is at least partially received in the second housing 22, and the second housing 22 has a horizontal bar joint 220 to be connected to the horizontal bar 10. It should be appreciated that, in other embodiments, it is also possible that the second housing 22 is partially received in the first housing 21, and the first housing 21 has a horizontal bar joint to be connected to the horizontal bar 10. The first housing 21 has a hollow cylindrical component 27, the second housing 22 has a deflection shaft 25 penetrating the hollow cylindrical component 27, the deflection shaft 25 is parallel to the horizontal bar 10, and the second housing 22 can pivot around the deflection shaft 25 relative to the first housing 21. Specifically, the deflection shaft 25 is a screw that runs through the hollow cylindrical component 27. It should be appreciated, in other embodiments, it is also possible that the second housing 22 is provided with a hollow cylindrical component and the first housing 21 is provided with a column penetrating through the hollow cylindrical component of the second housing 22, as long as the second housing 22 can pivot relative to the first housing 21.

An clastic member 26 is arranged between the first housing 21 and the second housing 22. In this embodiment, the hollow cylindrical component 27 is arranged at one end of the first housing 21, and the clastic member 26 is arranged at an end of the first housing 21 away from the hollow cylindrical component 27. In a case where the elastic member 26 is compressed, the deflection shaft 25 rotates in the hollow cylindrical component 27 to drive the second housing 22 to pivot relative to the first housing 21, thereby realizing the deflection of the folding bracket 100. Since the second housing 22 can pivot relative to the first housing 21 and the clastic member 26 is arranged between the first housing 21 and the second housing 22, the folding bracket 100 of can be deflected during use without overturning. In this way, the folding bracket 100 can be used as a bracket for a portable rocking chair or hammock, which improves the use comfort of portable furniture.

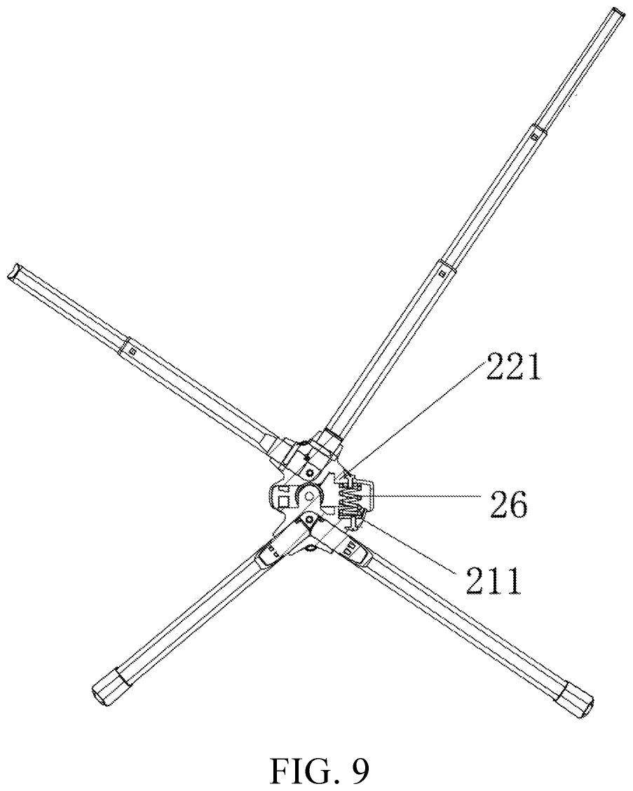

Preferably, as shown in FIGS. 9, the first housing 21 has a first limit groove 211, and the second housing 22 has a second limit groove 221, one end of the spring 26 is clamped in the first limit groove 211, and the other end of the spring 26 is clamped in the second limit groove 221. In this way, whether the spring 26 is compressed or stretched, it can provide resistance for the relative motion between the first housing 21 and the second housing 22, the user can lean back without worrying about falling over.

Preferably, an end of each first supporting component 23 connected to the first housing 21 is provided with a leg tooth portion 231 and the leg tooth portions of adjacent first supporting components 23 are engaged with each other. As a result, when one first supporting component 23 rotates relative to the base 20, adjacent first supporting components 23 can be driven to rotate simultaneously. An end of each second supporting component 24 connected to the second housing 22 is provided with an arm tooth portion 241 and the arm tooth portions 241 of adjacent second supporting components 24 are engaged with each other. As a result, when one second supporting component 24 rotates relative to the base 20, adjacent second supporting components 24 can be driven to rotate simultaneously. In this way, operations for unfolding or folding the folding bracket 100 are simplified. It should be appreciated, in other embodiments, the first supporting components or the second supporting components may be respectively pivoted to the bases in a non-linkage manner, and the first supporting components or the second supporting components may also be detachably connected to the bases. The deflectable folding bracket of the present invention can be folded as long as the first supporting components or the second supporting components are removed from the bases.

In this embodiment, the second supporting component 24 includes a front second supporting component 243 and a rear second supporting component 244, the rear second supporting component 244 is longer than the front second supporting component 243, the deflection shaft 25 is close to the front second supporting component 243, and the elastic member 26 is close to the rear second supporting component 244. The elastic member 26 is configured as a spring. A first limiting column 212 protruding toward the second housing 22 is arranged at a position on the first housing 21 connected to the elastic member 26. A second limiting column 222 protruding toward the first housing 21 is arranged at a position on the second housing 22 connected to the elastic member 26. In a case where the elastic member 26 is compressed, the first limiting post 212 and the second limiting post 222 push against each other to limit the deflection angle of the second housing 22 relative to the first housing 21. In this way, in a case where the folding bracket 100 is used in a rocking chair, the user can lean back without worrying about falling over.

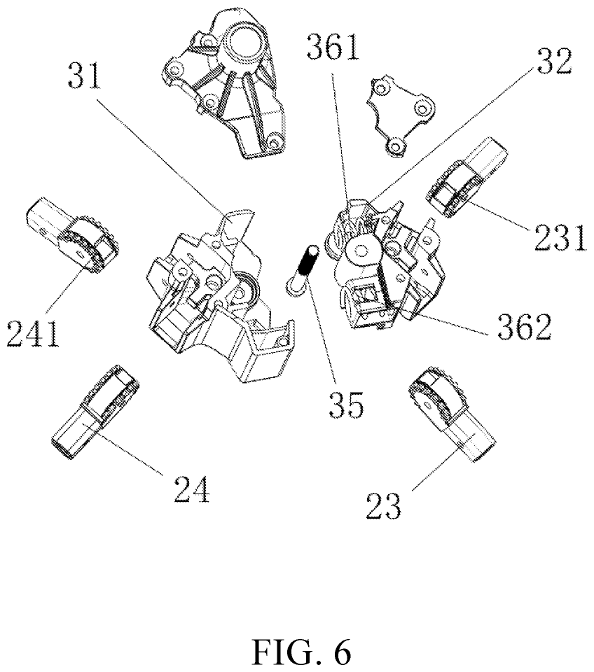

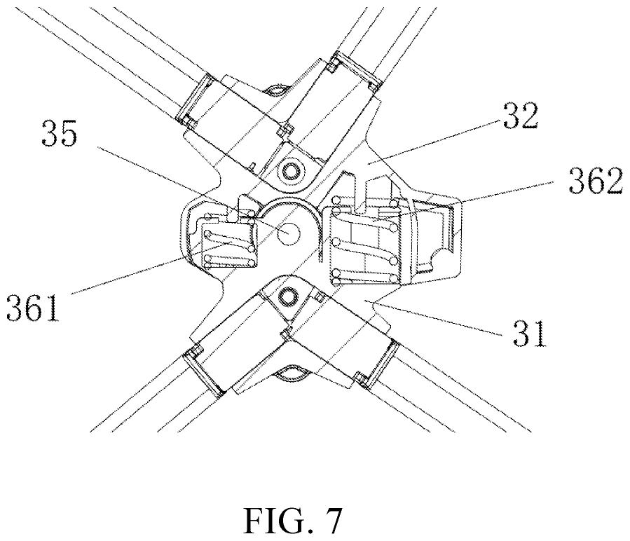

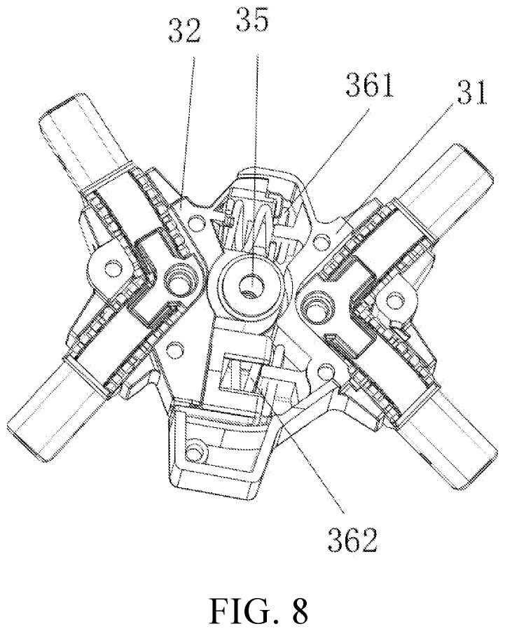

In another embodiment, as shown in FIGS. 6-8, the deflection shaft 35 is arranged in the first housing 31, and the elastic member includes a first spring 361 and a second spring 362 that are respectively arranged on two sides of the deflection shaft. The second housing 32 may be deflected towards the first spring 361, and may also be deflected towards the second spring 362. Specifically, the first spring 361 is longer than the second spring 362. That is, an angle at which the second housing 32 deflects toward the first spring 361 is smaller than an angle at which the second housing 32 deflects toward the second spring 362. In this way, in a case where the folding bracket is used in portable furniture, the user can swing forward or backward, which increases the fun of using the portable furniture.

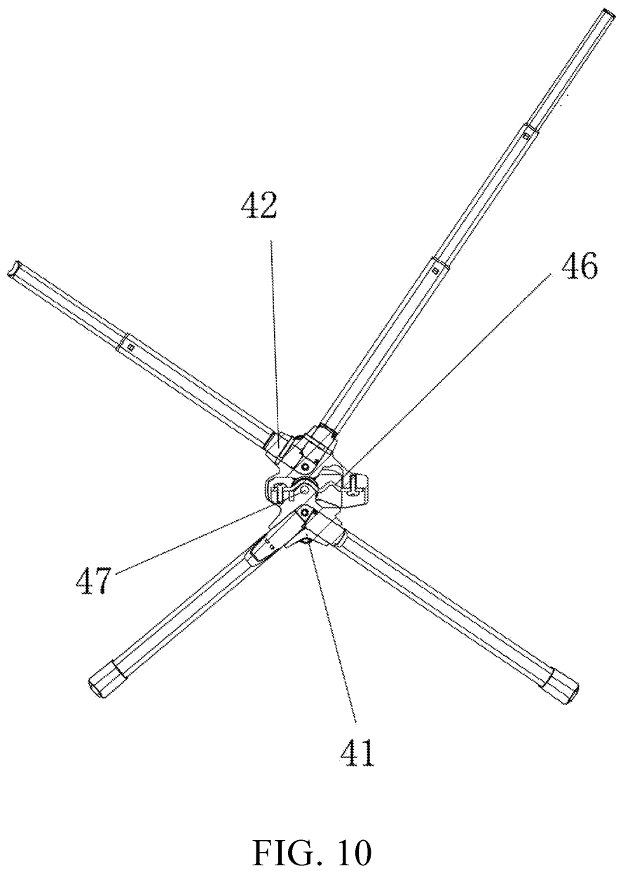

In another embodiment, as shown in FIGS. 10, the hollow cylindrical component 47 is arranged in the housing space, the clastic member 46 is an elastic strip arranged on the hollow cylindrical component 47. Preferably, the elastic strip 46 is wave shaped, the position in contact with the hollow cylindrical component 47 matches the shape of the hollow cylindrical component 47. As the elastic member 46 is arranged on the hollow cylindrical component 47, the middle of the elastic strip 46 is supported by the hollow cylindrical body 47, the elastic strip 46 will not twist when subjected to force, and has better ductility when bent vertically.

The deflectable folding bracket of the present invention includes a horizontal bar and two bases respectively arranged at two ends of the horizontal bar, wherein each base comprises a first housing and a second housing forming a housing space with the first housing, an elastic member is arranged in the housing space, the first housing has a hollow cylindrical component, the second housing has a deflection shaft penetrating the hollow cylindrical component, the deflection shaft is parallel to the horizontal bar, the second housing can pivot around the deflection shaft relative to the first housing, and the base further comprises a plurality of first supporting components connected to the first housing and a plurality of second supporting components connected to the second housing. Since the second housing can pivot relative to the first housing and the elastic member is arranged between the first housing and the second housing, the folding bracket of the present invention can be deflected during use without overturning.

The above embodiments are only used for illustrating rather than limiting the technical solutions of the present invention. Although the present invention is described in detail with reference to the above embodiments, those of ordinary skill in the art should understand that they still can make modifications to the technical solutions disclosed in the above embodiments or make equivalent substitutions to some or all of technical features thereof, and these modifications or substitutions should not cause the essence of the corresponding technical solutions to depart from the scope of the technical solutions of the embodiments of the present invention.

What is claimed is:

1. A deflectable folding bracket, comprising
a horizontal bar and
two bases respectively arranged at two ends of the horizontal bar, wherein
each base comprises a first housing and a second housing forming a housing space with the first housing, an elastic member is arranged in the housing space, the first housing has a hollow cylindrical component, the second housing has a deflection shaft penetrating the hollow cylindrical component, the deflection shaft is parallel to the horizontal bar, the second housing can pivot around the deflection shaft relative to the first housing, and the base further comprises a plurality of first supporting components connected to the first housing and a plurality of second supporting components connected to the second housing.

2. The deflectable folding bracket according to claim 1, wherein the hollow cylindrical component is arranged at one end of the first housing, and the elastic member is a spring arranged at one end of the first housing away from the hollow cylindrical component.

3. The deflectable folding bracket according to claim 2, wherein the first housing has a first limit groove, and the second housing has a second limit groove, one end of the spring is clamped in the first limit groove, and the other end of the spring is clamped in the second limit groove.

4. The deflectable folding bracket according to claim 1, wherein the hollow cylindrical component is arranged in the housing space, the elastic member comprises a first spring arranged on one side of the deflection shaft and a second spring arranged on an other side of the deflection shaft.

5. The deflectable folding bracket according to claim 4, wherein the first spring is shorter than the second spring in an uncompressed state.

6. The deflectable folding bracket according to claim 1, wherein the hollow cylindrical component is arranged in the housing space, the elastic member is an elastic strip arranged on the hollow cylindrical component.

7. The deflectable folding bracket according to claim 6, wherein the elastic strip is wave shaped.

8. The deflectable folding bracket according to claim 1, wherein an end of each first supporting component connected to the first housing is provided with a leg tooth portion, and the leg tooth portions of adjacent first supporting components are engaged with each other.

9. The deflectable folding bracket according to claim 1, wherein an end of each second supporting component connected to the second housing is provided with an arm tooth portion, and the arm tooth portions of adjacent second supporting components are engaged with each other.

10. The deflectable folding bracket according to claim 1, wherein the each second supporting component comprises a front second supporting component and a rear second supporting component, the rear second supporting component is longer than the front second supporting component, and the deflection shaft is arranged toward the front second supporting component.

11. The deflectable folding bracket according to claim 1, wherein the first housing is at least partially received in the second housing, and the second housing has a horizontal bar joint to be connected to the horizontal bar.
